(19) United States
(12) Patent Application Publication
(10) Pub. No.: US 2026/0036721 A1
(43) Pub. Date: Feb. 5, 2026

(54) METHODS AND SYSTEMS FOR OPTICAL DEVICES WITH FUSION BONDED GLASS SUBSTRATES

(71) Applicant: Meta Platforms Technologies, LLC, Menlo Park, CA (US)

(72) Inventors: Kuan-Ting Chiang, Taoyuan (TW); William Chang, Cupertino, CA (US)

(21) Appl. No.: 19/280,045

(22) Filed: Jul. 24, 2025

Related U.S. Application Data
(60) Provisional application No. 63/677,376, filed on Jul. 30, 2024.

(51) Int. Cl. G02B 1/12; G02B 27/00; G02B 27/01

(52) U.S. Cl. CPC G02B 1/12; G02B 27/0093; G02B 27/0172; G02B 2027/014; G02B 2027/0178

(57) ABSTRACT

An optical device includes a first layer having a first surface and a first set of surface coatings. The optical device includes a second layer having a second surface and an opposing third surface, and a second set of surface coatings. A first surface coating in the second set of surface coatings is bonded to the third surface. An outer surface coating in the first set of surface coatings is covalently bonded to the second surface of the second layer through a plurality of covalent interactions of the form X—O—Y, thereby attaching the first layer and the second layer to each other. Each X is an atom of the outer surface coating of the first set of surface coatings, O is an oxygen atom, and each Y is an atom of the second layer.

### CROSS-REFERENCE TO RELATED APPLICATION

The present Application claims priority to U.S. Patent Application No. 63/677,376, entitled “Methods and Systems for Optical Devices with Fusion Bonded Glass Substrates,” filed Jul. 30, 2024, which is hereby incorporated by reference in its entirety for all purposes.

### TECHNICAL FIELD

The present disclosure relates generally to optical devices and, more specifically, to optical devices with fusion bonded glass substrates.

### BACKGROUND

Optical devices are widely used in artificial reality and other light-guiding applications. Optical devices are generally fabricated with multiple layers and optical coatings. Some of these optical devices use adhesives as a bonding agent between the layers and/or optical coatings. Additionally or alternatively, optical devices have glass substrates that are bonded to each other with adhesives.

### SUMMARY

However, there is a need for improving the reliability, shatter resistance, and optical transparencies for optical devices because adhesives are prone to mechanical failures and are limited in the index of refraction. In addition, there is a need to circumvent the use of adhesives as a bonding agent for optical devices in certain applications.

This application describes fusion bonded glass layers in optical devices. The disclosed devices are fabricated with fusion bonded glass surfaces and configured to provide improved optical transparencies and greater resilience to mechanical failures. Additionally or alternatively, fusion bonded glass surfaces enable improved performance characteristics for optical devices without the use of adhesives.

In accordance with some embodiments, an optical device includes a first transparent oxide layer having a first surface and a first set of surface coatings, wherein each surface coating in the first set of surface coatings is bonded to another surface coating in the first set of surface coatings, and a first surface coating in the first set of surface coatings is bonded to the first surface, thereby attaching the first set of surface coatings to the first transparent oxide layer, at least one surface coating in the first set of coatings is a partial reflective coating. The optical device includes a second transparent oxide layer having a second surface and an opposing third surface, and a second set of surface coatings, wherein each surface coating in the second set of surface coatings is bonded to another surface coating in the second set of coatings, and a first surface coating in the second set of surface coatings is bonded to the third surface, at least one surface coating in the second set of surface coatings is a partial reflective coating. An outer surface coating in the first set of surface coatings is covalently bonded to the second surface of the second transparent oxide layer through a plurality of covalent interactions of the form X—O—Y, thereby attaching the first transparent oxide layer and the second transparent oxide layer to each other. Each X is an atom of the outer surface coating of the first set of surface coatings, O is an oxygen atom, each Y is an atom of the second transparent oxide layer, and wherein the first and second transparent oxide layers attached to each other collectively have a bow of less than 100 micrometers or have a total thickness variation (TTV) of less than 5 microns.

In some embodiments, the second transparent oxide layer is composed of silicon dioxide and each Y is a silicon (Si) atom.

In some embodiments, each X and each Y is a Si atom.

In some embodiments, the second transparent oxide layer is composed of zirconium oxide and each Y is a Zr atom.

In some embodiments, the second transparent oxide layer is composed of titanium dioxide and each Y is a Ti atom.

In some embodiments, the second transparent oxide layer is composed of aluminum oxide and each Y is an Al atom.

In some embodiments, the second transparent oxide layer is composed of indium tin oxide and each Y is an In or Sn atom.

In some embodiments, the second transparent oxide layer is composed of bismuth oxide and each Y is a Bi atom.

In some embodiments, the second transparent oxide layer is composed of lanthanum oxide and each Y is a La atom.

In some embodiments, the second transparent oxide layer is composed of yttrium oxide and each Y is an atom of yttrium.

In some embodiments, each X and each Y is independently a Si, Zr, Ti, Al, In, Sn, Bi, La, or yttrium atom.

In some embodiments, a coating in the first set of coatings is an index-matching coating, a dielectric multilayer coating, a partially transmissive coating, or a graded index coating.

In some embodiments, a coating in the second set of coatings is an index-matching coating, a dielectric multilayer coating, a partially transmissive coating, or a graded index coating.

In some embodiments, the optical device is an augmented reality device.

In some embodiments, the outer surface coating in the first set of surface coatings is deposited on the first surface coating in the first set of surface coatings.

In some embodiments, the first surface coating has a microroughness of less than 2 nm.

In some embodiments, the first surface coating has a microroughness of less than 0.5 nm.

In some embodiments, a second surface coating in the first set of surface coatings is deposited on the first surface coating, and the outer surface coating in the first set of surface coatings is deposited on the second surface coating in the first set of surface coatings.

In some embodiments, the second surface coating has a microroughness of less than 2 nm.

In some embodiments, the second surface coating has a microroughness of less

than 0.5 nm.

In some embodiments, the second surface of the second transparent oxide layer has a microroughness of less than 2 nm.

In some embodiments, the second surface of the second transparent oxide layer has a microroughness of less than 0.5 nm.

In some embodiments, the first transparent oxide layer is a portion of a wafer that is 100 mm, 150 mm, 200 mm, or 300 mm in diameter.

In some embodiments, the first transparent oxide layer has surface area that is between 3 mm and 50 mm in a first dimension and between 3 mm and 50 mm in a second dimension orthogonal to the first dimension.

In some embodiments, a thickness of the first transparent oxide layer varies between 50 microns and 1 mm.

In some embodiments, a thickness of the second transparent oxide layer varies between 100 nm and 900 nm.

In some embodiments, the first transparent oxide layer is a core layer of a waveguide.

In some embodiments, the at least one surface coating in the first set of surface coatings is a cladding layer of the waveguide.

In some embodiments, the at least one surface coating in the first set of surface coatings is a metal oxide coating or a dielectric coating.

In some embodiments, the at least one surface coating in the first set of surface coatings is partially transmissive to visible light.

The disclosed optical devices and methods may replace conventional optical devices and methods. The disclosed optical devices and methods may complement conventional optical devices and methods.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the figures.

FIGS. 1A, 1B, and 1C are schematic diagrams illustrating glass substrates bonded with adhesive in accordance with some embodiments.

FIGS. 2A and 2B are schematic diagrams illustrating fusion bonded glass substrates in an optical device in accordance with some embodiments.

FIGS. 3A, 3B, 3C, 3D, and 3E are schematic diagrams illustrating fusion bonding processes of glass substrates in accordance with some embodiments.

FIG. 4 is an infrared image illustrating fusion bonding of glass substrates in accordance with some embodiments.

FIG. 5 is a schematic illustration of a fusion bonding process in silicon oxides in accordance with some embodiments.

FIG. 6 shows a schematic illustration of an optical device with fusion bonded surfaces in accordance with some embodiments.

FIG. 7 is a perspective view of a display device in accordance with some embodiments.

FIG. 8 is a block diagram of a system including a display device in accordance with some embodiments.

FIG. 9 is an isometric view of a display device in accordance with some embodiments.

These figures are not drawn to scale unless indicated otherwise.

### DETAILED DESCRIPTION

As described above, conventional optical devices that have materials with adhesive bonds have limited index of refraction and poor shatter-resistance. The optical devices described herein provide high optical transparencies, long-term reliability, shatter-resistance, seamless permanent bonds between multiple material layers, and improved mechanical durability.

Reference will now be made to embodiments, examples of which are illustrated in the accompanying drawings. In the following description, numerous specific details are set forth in order to provide an understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

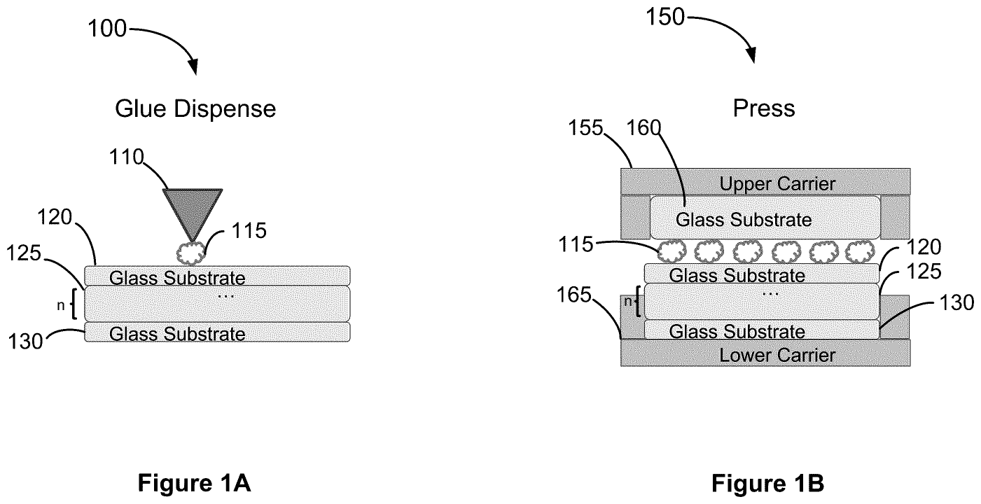

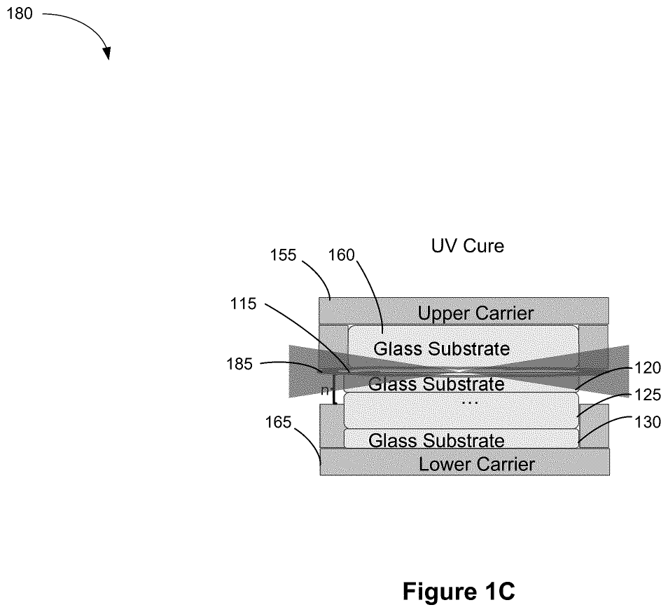

FIGS. 1A-1C are schematic diagrams illustrating glass substrates bonded with adhesive in accordance with some embodiments.

FIG. 1A is a schematic diagram illustrating a glue dispensing mechanism for adhesive-based bonding of glass substrates. A glue dispensing mechanism 110 dispenses glue 115 (e.g., epoxy-based adhesives, acrylate-based adhesives, sodium silicate, etc.) over a top surface of a stack of glass substrates (e.g., glass substrate 120, 125, and 130).

FIG. 1B is a schematic diagram illustrating adhesive-based bonding of glass substrates. For example, the stack of glass substrates is held in position with a lower carrier mechanism 165 and an upper glass substrate is held in position with an upper carrier mechanism 155. The top surface of the stack of glass substrates has a layer of glue 115 dispensed using the glue dispensing mechanism 110. The stack of glass substrates and the upper glass substrate 160 are aligned with respect to each other along one or more axis (e.g., x-axis, y-axis, vertical z-axis) and pressed together to facilitate a uniform formation of the layer of glue 115 between the upper glass substrate 160 and the top surface of the stack of glass substrates.

FIG. 1C is a schematic diagram illustrating curing of an adhesive dispensed between glass substrates. For example, ultraviolet (UV) light 185 is impinged onto the layer of glue 115 dispensed between the stack of glass substrates (e.g., glass substrates 120, 125, 130, etc.) and the upper glass substrate 160. Photoinitiators in the glue absorb the UV light to generate reactive species that initiate a polymerization process. The polymerization process converts the liquid glue into a solid polymer, bonding the stack of glass substrates with the upper glass substrate 160.

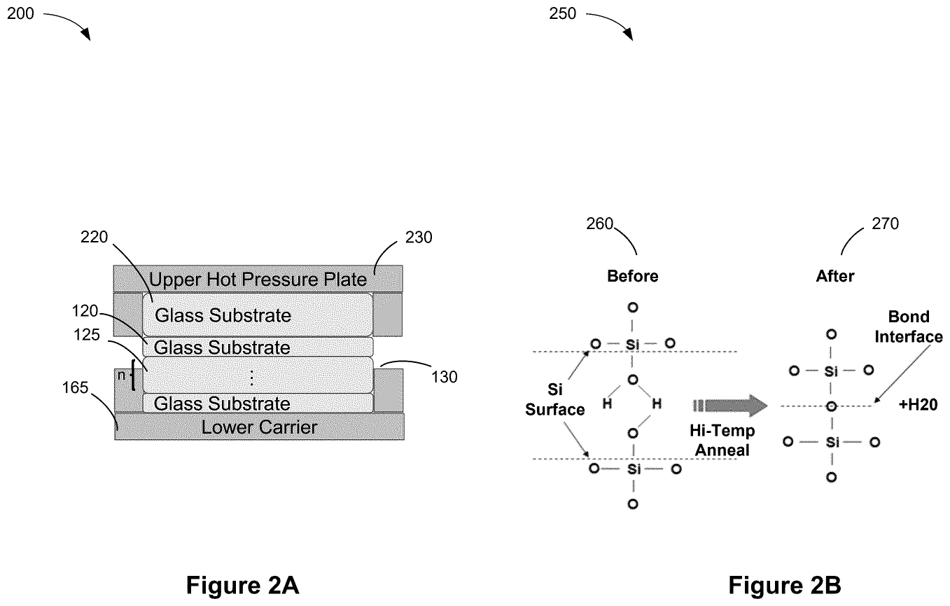

FIGS. 2A and 2B are schematic diagrams illustrating fusion bonded glass substrates. FIG. 2A is a schematic illustration of a stack of glass substrates (e.g., glass substrates 120, 125, 130 as described in FIGS. 1A-1C) including a top surface that is fusion bonded with a lower surface of glass substrate 220. As described with respect to FIGS. 1A-1C, the stack of the glass substrates is held by the lower carrier mechanism 165. In some embodiments, the upper glass substrate 220 is held by an upper carrier mechanism that includes a hot pressure plate 230. In some embodiments, the lower carrier mechanism 165 and the upper carrier mechanisms enable alignment of the glass substrates for accurate fusion bonding.

Fusion bonding enables seamless covalent bonding between the lower surface of the upper glass substrate and the top surface of the stack of the glass substrates without the use of any additional materials (e.g., epoxy, glue, etc.). By avoiding the use of additional bonding materials, fusion bonds generate strong permanent attachments that have high structural integrity and mechanical robustness. Additionally or alternatively, fusion bonding can be used for forming a seamless permanent covalent bond between silicon dioxide coatings, a silicon dioxide coating and a glass substrate, and/or other similarly compatible materials (e.g., plastics, metals, composites, etc.) used in the fabrication of optical devices.

In some embodiments, fusion bonding can be used at a wafer level to create a desired device stack (e.g., silicon-on-insulator (SOI)/optical coating/silicon dioxide (SiO₂)/SiO₂/optical coating/silicon nitride/SOI, SOI/optical coatings/SiO₂/SiO₂/sapphire/SOI. etc.) with a first device stack fusion bonded with a second device stack through fusion bonded SiO₂layers. In some embodiments, the fusion bonded silicon dioxide layers are deposited using chemical vapor deposition and/or sputter deposition. Surface polishing can be used to achieve surface requirements for plasma activated fusion bonding including surface roughness less than 2 nm, bow less than 50 microns, and total thickness variation (TTV) of less than 5 microns for wafer sizes varying from 100 mm up to 300 mm. In some embodiments, surface requirements for fusion bonding without plasma activation are surface roughness less than 1 nm, bow less than 30 microns, and TTV of less than 3 microns for wafer sizes varying from 100 mm up to 300 mm.

FIG. 2B shows an illustration of covalent bond formation during a fusion bonding process. Fusion bonding of silicon dioxide surfaces replaces hydroxyl (—OH) terminated surface bonds 260 with permanent Si—O—Si covalent bonds 270. Fusion bonding occurs during an annealing step. In some embodiments, high annealing temperatures (e.g., exceeding 800° C.) enable void-free fusion bonding of surfaces without plasma pre-treatment of the surfaces. In some embodiments, plasma pre-treatment of the surfaces to be fusion bonded can enable void-free fusion bonding at lower annealing temperatures (e.g., varying between room temperature and 200° C.).

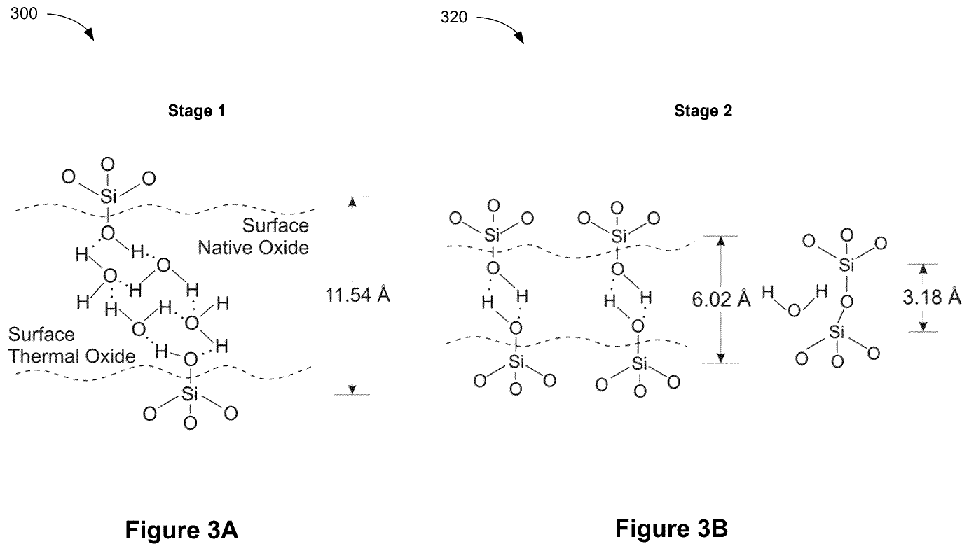

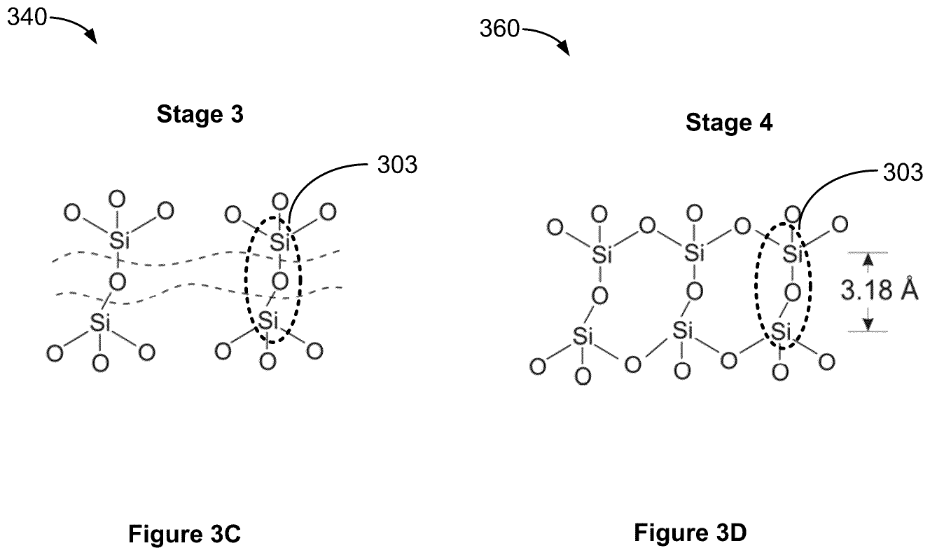

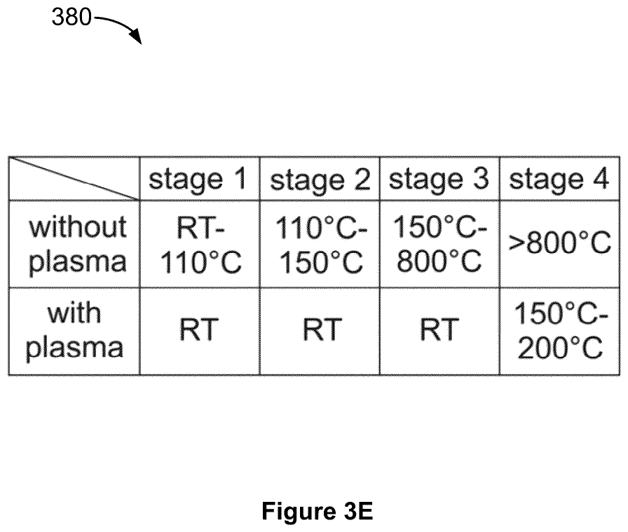

FIGS. 3A-3E are schematic diagrams illustrating a fusion bonding process in accordance with some embodiments. In some embodiments, the fusion bonding process consists of four stages as shown in FIGS. 3A-3E. FIG. 3A illustrates stage 1 of the fusion bonding process that begins with the presence of hydrogen bonds in native surface oxides. Stages 2 and 3 as shown in FIGS. 3B and 3C show progression of the surface bonds to covalent bonds until thermal oxide softening occurs (Si—OH+HO—Si→Si—O—Si+H₂O) at high anneal temperatures (e.g., above 800° C.) at stage 4 as shown in FIG. 3D.

FIG. 3E illustrates example process conditions for fusion bonding between silicon dioxide surfaces. Stage 1 is indicative of the formation of native surface oxides (FIG. 3A) for anneal process temperatures varying from room temperature up to 110° C. without plasma treatment and room temperatures with plasma treatment. Stage 2 is indicative of the formation of silicon dioxide with suboxide species (FIG. 3B) for anneal process temperatures varying from 110° C. up to 150° C. without plasma treatment and room temperatures with plasma treatment. Stage 3 is indicative of the formation of higher density silicon dioxide with some surface roughness limitations (FIG. 3C) for anneal process temperatures varying from 150° C. up to 800° C. without plasma treatment and room temperatures with plasma treatment. Stage 4 is indicative of purely covalently bonded silicon dioxide for anneal process temperatures exceeding 800° C. without plasma treatment and 150° C. up to 200° C. with plasma treatment. The utilization of plasma treatment results in higher quality fusion bonding at much lower annealing temperatures.

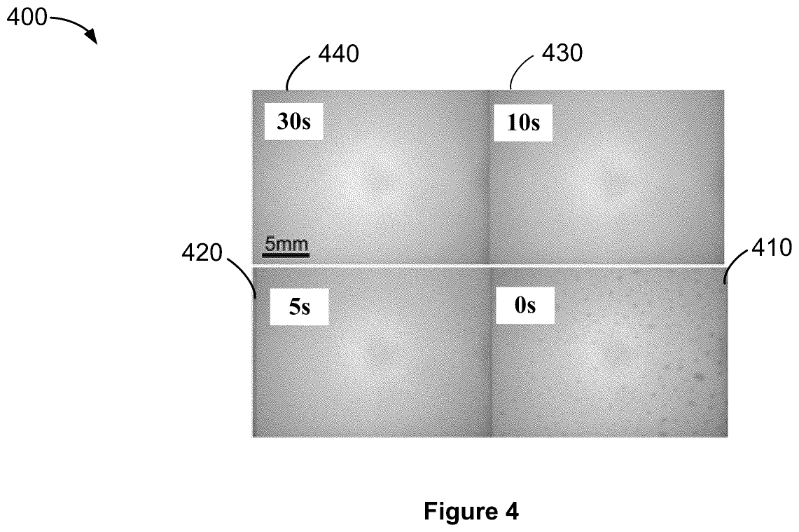

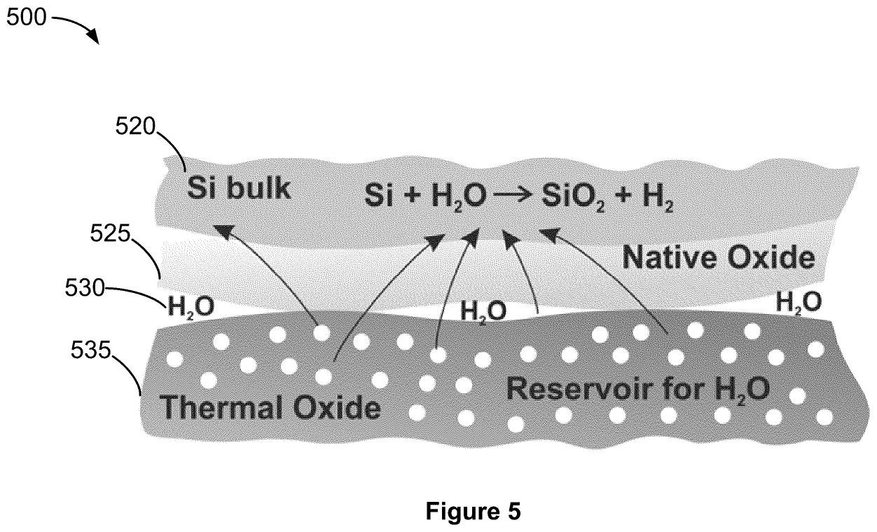

FIG. 4 shows infrared images of silicon-silicon (Si—Si) bonded surfaces pre-treated under varying plasma conditions. For example, the silicon-silicon bonded surface with no pre-treatment (e.g., before plasma treatment 410) has more defects. With increasing plasma treatment (e.g., 5 second plasma treatment 420, 10 second plasma treatment 430, 30 second plasma treatment 440), the defects between the silicon-silicon bonded surfaces are seen to decrease as evidenced by a decrease in dark spots in the corresponding images. In some embodiments, the fusion bonding process of silicon substrates requires a minimal oxide thickness (e.g., >100 nm) to prevent hydrogen bubbles. In some embodiments, plasma pre-treatment can reduce bubble size and/or eliminate hydrogen bubbles. Plasma activation strengthens wafer bonding through hydrophilicity, adhesion, and oxide growth, resulting in increased bond strength and interfacial gap closure as described below in FIG. 5 in more detail.

FIG. 5 is a schematic illustration of nanogap closing mechanisms during a fusion bonding process between bulk silicon with a native oxide layer and a thermally grown silicon dioxide layer. Bulk silicon 520 typically has a thin (e.g., 1-2 nm) native oxide layer 525 formed during exposure to air. This layer is primarily composed of silicon dioxide (SiO₂) and silicon suboxide species (SiOₓ, where x is less than 2). The native oxide layer is not defect free due to the presence of silicon suboxide species. During fusion bonding (e.g., at high annealing temperatures) with a thermally grown silicon dioxide surface 535, nanogaps (e.g., nanogap 530) that can contain water, close with the formation of high-quality silicon dioxide. For example, at high temperatures, oxidation is much more rapid due to increased diffusion rates of oxygen and silicon atoms forming a more uniform silicon dioxide layer. The primary oxidation reaction is: Si+O₂→SiO₂. The higher temperatures reduce the presence of silicon suboxides, leading to a purer silicon dioxide layer with fewer defects, no nanogaps, and improved optical and mechanical properties.

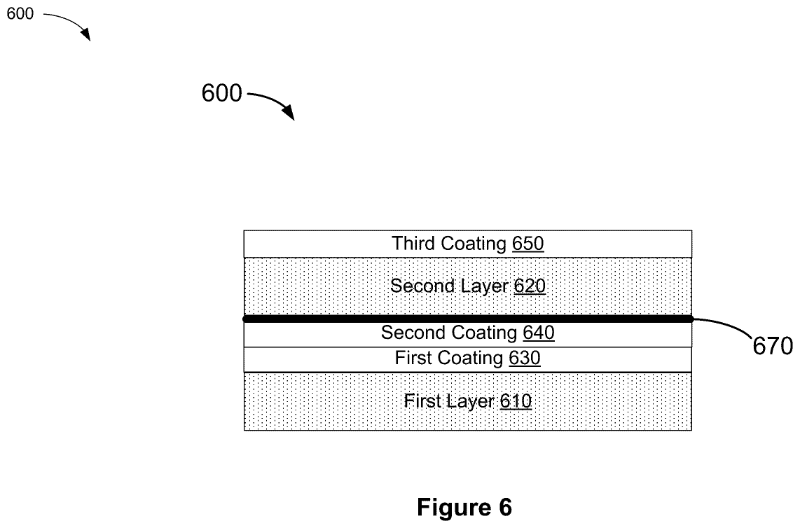

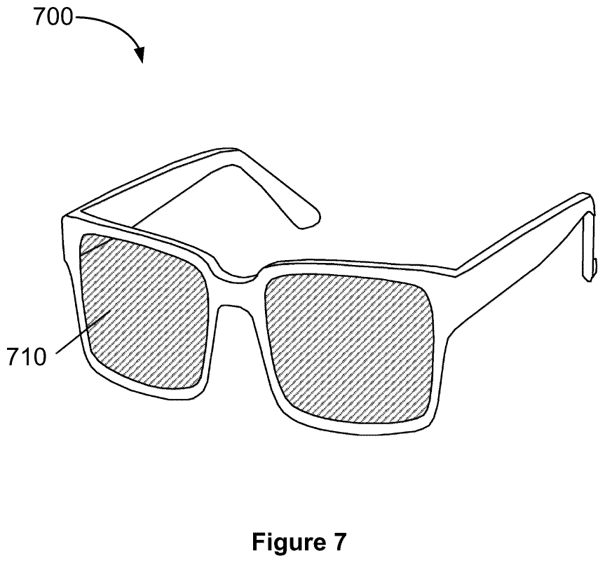

FIG. 6 illustrates a portion of an optical device with fusion bonded optical layers in accordance with some embodiments. In some embodiments, the portion of the optical device 600 has a first layer 610 (e.g., comprising silicon dioxide, glass substrate, silicon carbide, quartz, sapphire, etc.) with one or more optical coatings (e.g., first coating 630, second coating 640, etc.) disposed thereon. As used herein, the terms “optical coating” and “surface coating” are used interchangeably. At least one of these optical coatings is fusion bonded to a lower surface of a second layer 620 (e.g., the second layer comprising silicon dioxide, glass substrate, silicon carbide, quartz, sapphire, etc.). In some embodiments, the second layer has at least one optical coating disposed on a top surface of the second layer (e.g., third optical coating 650). In some embodiments, the second coating 640 is a layer of deposited silicon dioxide. The deposited silicon dioxide layer can be fabricated using chemical vapor deposition or sputter deposition. Deposition of silicon dioxide reduces non-bond performance by avoiding hydrogen bubbles. In some embodiments, additional polishing steps of the surfaces of the second layer improve surface roughness to meet the surface roughness requirements for fusion bonding.

In some embodiments, one or more of the optical coating layers (e.g., 630, 640, 650) is an index-matching coating, a dielectric multilayer coating, a partially transmissive coating, or a graded index coating.

In some embodiments, the first layer 610 and/or the second layer 620 is composed of silicon dioxide, zirconium oxide, titanium dioxide, aluminum oxide, indium tin oxide, bismuth oxide, lanthanum oxide, or yttrium oxide. Additionally or alternatively, the layers in the portion of the optical device 600 can be composed of other bondable materials compatible with optical device fabrication.

In some embodiments, the first coating 630 and/or the second coating 640 has a microroughness of less than 2 nm.

In some embodiments, the first layer 610 and/or the second layer 620 has a microroughness of less than 5 nm, 4 nm, 3 nm, or 2 nm.

In some embodiments, the first coating 630 and/or the second coating 640 has a microroughness of less than 1.0 nm, 0.90 nm, 0.80 nm, 0.70 nm, 0.60 nm, or 0.50 nm.

In some embodiments, the first layer 610 and/or the second layer 620 has a microroughness of less than 1.0 nm, 0.90 nm, 0.80 nm, 0.70 nm, 0.60 nm, or 0.50 nm.

In some embodiments, the first layer 610 and/or the second layer 620 is a portion of a wafer, and the wafer is 100 mm, 150 mm, 200 mm, or 300 mm in diameter. In some embodiments, the first layer 610 and/or the second layer 620 is a portion of a wafer, and the wafer has a diameter that is between 100 mm and 500 mm. In some embodiments, the first layer 610 and/or the second layer 620 is a portion of a wafer, and the wafer has a diameter that is greater than 50 nm, greater than 100 nm, greater than 150 nm, greater than 200 nm, greater than 250 nm, or greater than 300 nm.

In some embodiments, the first layer 610 has surface area that is between 3 mm and 50 mm in a first dimension and between 3 mm and 50 mm in a second dimension orthogonal to the first dimension.

In some embodiments, the first layer 610 has surface area that is between 10mm and 100 mm in a first dimension and between 100 mm and 100 mm in a second dimension orthogonal to the first dimension.

In some embodiments, the first layer 610 has surface area that is between 15mm and 200 mm in a first dimension and between 15 mm and 200 mm in a second dimension orthogonal to the first dimension.

In some embodiments, the first layer 610 has surface area that is between 5 mm and 50 mm in a first dimension and between 5 mm and 50 mm in a second dimension orthogonal to the first dimension.

In some embodiments, the first layer 610 and/or the second layer 620 is a transparent oxide layer.

In some embodiments, the first layer 610 and/or the second layer 620 is a light-guiding layer of a waveguide, ring resonator, optical coupler, optical splitter, optical switch, optical multiplexer, or other photonic component.

In some embodiments, the first layer 610 and/or the second layer 620 is a cladding layer of a waveguide, ring resonator, optical coupler, optical splitter, optical switch, optical multiplexer, or other photonic component.

In some embodiments, at least one coating is a cladding layer of a waveguide, ring resonator, optical coupler, optical splitter, optical switch, optical multiplexer, or another photonic component.

In some embodiments, the thickness of the first layer varies between 50 microns and 1 mm. In some embodiments, the thickness of the first layer varies between 100 microns and 800 microns. In some embodiments, the thickness of the first layer varies between 300 microns and 1.2 mm. In some embodiments, the thickness of the first layer varies between 400 microns and 1.4 mm.

In some embodiments, the thickness of the second layer varies between 100 nm and 900 nm. In some embodiments, the thickness of the second layer varies between 100 microns and 800 microns. In some embodiments, the thickness of the second layer varies between 300 microns and 1.2 mm. In some embodiments, the thickness of the second layer varies between 400 microns and 1.4 mm.

In some embodiments, at least one optical coating in the one or more coatings on first layer 610 and/or on the second layer 620 comprises a metal, metal oxide, fluoride, or a dielectric.

In some embodiments, at least optical coating in the one or more coatings on first layer 610 and/or on the second layer 620 is partially transmissive to visible light.

In some embodiments, each of the one or more coatings on first layer 610 and on the second layer 620 is partially transmissive to visible light.

FIG. 7 illustrates display device 700 in accordance with some embodiments. In some embodiments, display device 700 is configured to be worn on a head of a user (e.g., by having the form of spectacles or eyeglasses, as shown in FIG. 7) or to be included as part of a helmet that is to be worn by the user. When display device 700 is configured to be worn on a head of a user or to be included as part of a helmet, display device 700 is called a head-mounted display. Alternatively, display device 700 is configured for placement in proximity of an eye or eyes of the user at a fixed location, without being head-mounted (e.g., display device 700 is mounted in a vehicle, such as a car or an airplane, for placement in front of an eye or eyes of the user). As shown in FIG. 7, display device 700 includes display 710. Display 710 is configured for presenting visual contents (e.g., augmented reality contents, virtual reality contents, mixed reality contents, or any combination thereof) to a user.

In some embodiments, an optical device (e.g., portion of the optical device 600, 710) may be used in display devices such as head-mounted display devices (e.g., 700). In some embodiments, an optical device (e.g., 710) may be implemented as multifunctional optical components in near-eye displays for augmented reality (“AR”), virtual reality (“VR”), and/or mixed reality (“MR”). For example, the disclosed optical elements or devices may be implemented as optical dimming elements (e.g., variable intensity filters), etc., which may significantly reduce the weight and size, and enhance the optical performance of the head-mounted display devices. For example, the optical device 710 includes the optical layer stack described above with respect to FIG. 6.

Exemplary embodiments of head-mounted display devices for implementing an optical device (e.g., 710) are described with respect to FIGS. 7-9.

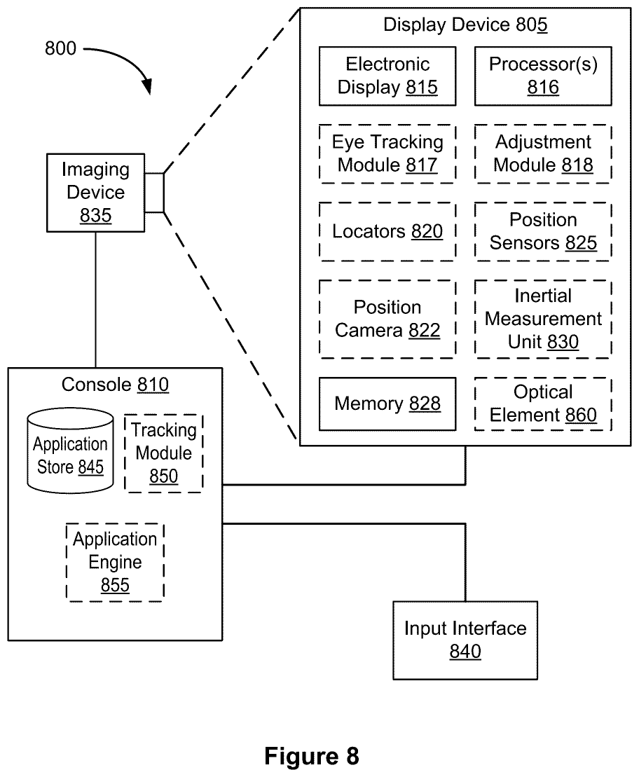

In some embodiments, display device 700 includes one or more components described herein with respect to FIG. 8. In some embodiments, display device 700 includes additional components not shown in FIG. 8.

FIG. 8 is a block diagram of system 800 in accordance with some embodiments. The system 800 shown in FIG. 8 includes display device 805 (which can correspond to optical device 600 shown in FIG. 6), imaging device 835, and input interface 840 that are each coupled to console 810. While FIG. 8 shows an example of system 800 including one display device 805, imaging device 835, and input interface 840, in other embodiments, any number of these components may be included in system 800. For example, there may be multiple display devices 805 each having associated input interface 840 and being monitored by one or more imaging devices 835, with each display device 805, input interface 840, and imaging devices 835 communicating with console 810. In alternative configurations, different and/or additional components may be included in system 800. For example, in some embodiments, console 810 is connected via a network (e.g., the Internet or a wireless network) to system 800 or is self-contained as part of display device 805 (e.g., physically located inside display device 805). In some embodiments, display device 805 is used to create mixed reality by adding in a view of the real surroundings. Thus, display device 805 and system 800 described here can deliver augmented reality, virtual reality, and mixed reality.

In some embodiments, as shown in FIG. 5, display device 805 is a head-mounted display that presents media to a user. Examples of media presented by display device 805 include one or more images, video, audio, or some combination thereof. In some embodiments, audio is presented via an external device (e.g., speakers and/or headphones) that receives audio information from display device 805, console 810, or both, and presents audio data based on the audio information. In some embodiments, display device 805 immerses a user in an augmented environment.

In some embodiments, display device 805 also acts as an augmented reality (AR) headset. In these embodiments, display device 805 augments views of a physical, real-world environment with computer-generated elements (e.g., images, video, sound, etc.). Moreover, in some embodiments, display device 805 is able to cycle between different types of operation. Thus, display device 805 operate as a virtual reality (VR) device, an augmented reality (AR) device, as glasses or some combination thereof (e.g., glasses with no optical correction, glasses optically corrected for the user, sunglasses, or some combination thereof) based on instructions from application engine 855.

Display device 805 includes electronic display 815, one or more processors 816, eye tracking module 818, adjustment module 818, one or more locators 820, one or more position sensors 825, one or more position cameras 822, memory 828, inertial measurement unit (IMU) 830, one or more optical elements 860 or a subset or superset thereof (e.g., display device 805 with electronic display 815, one or more processors 816, and memory 828, without any other listed components). Some embodiments of display device 805 have different modules than those described here. Similarly, the functions can be distributed among the modules in a different manner than is described here.

One or more processors 816 (e.g., processing units or cores) execute instructions stored in memory 828. Memory 828 includes high-speed random access memory, such as DRAM, SRAM, DDR RAM or other random access solid state memory devices: and may include non-volatile memory, such as one or more magnetic disk storage devices, optical disk storage devices, flash memory devices, or other non-volatile solid state storage devices. Memory 828, or alternately the non-volatile memory device(s) within memory 828, includes a non-transitory computer readable storage medium. In some embodiments, memory 828 or the computer readable storage medium of memory 828 stores programs, modules and data structures, and/or instructions for displaying one or more images on electronic display 815.

Electronic display 815 displays images to the user in accordance with data received from console 810 and/or processor(s) 816. In various embodiments, electronic display 815 may comprise a single adjustable display element or multiple adjustable display elements (e.g., a display for each eye of a user). In some embodiments, electronic display 815 is configured to display images to the user by projecting the images onto one or more optical elements 860.

In some embodiments, the display element includes one or more light emission devices and a corresponding array of spatial light modulators. A spatial light modulator is an array of electro-optic pixels, opto-electronic pixels, some other array of devices that dynamically adjust the amount of light transmitted by each device, or some combination thereof. These pixels are placed behind one or more lenses. In some embodiments, the spatial light modulator is an array of liquid crystal-based pixels in an LCD (a Liquid Crystal Display). Examples of the light emission devices include: an organic light emitting diode, an active-matrix organic light-emitting diode, a light emitting diode, some type of device capable of being placed in a flexible display, or some combination thereof. The light emission devices include devices that are capable of generating visible light (e.g., red, green, blue, etc.) used for image generation. The spatial light modulator is configured to selectively attenuate individual light emission devices, groups of light emission devices, or some combination thereof. Alternatively, when the light emission devices are configured to selectively attenuate individual emission devices and/or groups of light emission devices, the display element includes an array of such light emission devices without a separate emission intensity array. In some embodiments, electronic display 815 projects images to one or more reflective elements 860, which reflect at least a portion of the light toward an eye of a user.

One or more lenses direct light from the arrays of light emission devices (optionally through the emission intensity arrays) to locations within each eyebox and ultimately to the back of the user's retina(s). An eyebox is a region that is occupied by an eye of a user located proximity to display device 805 (e.g., a user wearing display device 805) for viewing images from display device 805. In some cases, the eyebox is represented as a 10 mm×10 mm square. In some embodiments, the one or more lenses include one or more coatings, such as anti-reflective coatings.

In some embodiments, the display element includes an infrared (IR) detector array that detects IR light that is retro-reflected from the retinas of a viewing user, from the surface of the corneas, lenses of the eyes, or some combination thereof. The IR detector array includes an IR sensor or a plurality of IR sensors that each correspond to a different position of a pupil of the viewing user's eye. In alternate embodiments, other eye tracking systems may also be employed. As used herein, IR refers to light with wavelengths ranging from 700 nm to 1 mm including near infrared (NIR) ranging from 750 nm to 1500 nm.

Eye tracking module 817 determines locations of each pupil of a user's eyes. In some embodiments, eye tracking module 817 instructs electronic display 815 to illuminate the eyebox with IR light (e.g., via IR emission devices in the display element).

A portion of the emitted IR light will pass through the viewing user's pupil and be retro-reflected from the retina toward the IR detector array, which is used for determining the location of the pupil. Alternatively, the reflection off of the surfaces of the eye is used to also determine location of the pupil. The IR detector array scans for retro-reflection and identifies which IR emission devices are active when retro-reflection is detected. Eye tracking module 817 may use a tracking lookup table and the identified IR emission devices to determine the pupil locations for each eye. The tracking lookup table maps received signals on the IR detector array to locations (corresponding to pupil locations) in each eyebox. In some embodiments, the tracking lookup table is generated via a calibration procedure (e.g., user looks at various known reference points in an image and eye tracking module 817 maps the locations of the user's pupil while looking at the reference points to corresponding signals received on the IR tracking array). As mentioned above, in some embodiments, system 800 may use other eye tracking systems than the embedded IR one described herein.

Adjustment module 818 generates an image frame based on the determined locations of the pupils. In some embodiments, this sends a discrete image to the display that will tile subimages together thus a coherent stitched image will appear on the back of the retina. Adjustment module 818 adjusts an output (i.e., the generated image frame) of electronic display 815 based on the detected locations of the pupils. Adjustment module 818 instructs portions of electronic display 815 to pass image light to the determined locations of the pupils. In some embodiments, adjustment module 818 also instructs the electronic display to not pass image light to positions other than the determined locations of the pupils.

Adjustment module 818 may, for example, block and/or stop light emission devices whose image light falls outside of the determined pupil locations, allow other light emission devices to emit image light that falls within the determined pupil locations, translate and/or rotate one or more display elements, dynamically adjust curvature and/or refractive power of one or more active lenses in the lens (e.g., microlens) arrays, or some combination thereof.

Optional locators 820 are objects located in specific positions on display device 805 relative to one another and relative to a specific reference point on display device 805. A locator 820 may be a light emitting diode (LED), a corner cube reflector, a reflective marker, a type of light source that contrasts with an environment in which display device 805 operates, or some combination thereof. In embodiments where locators 820 are active (e.g., an LED or other type of light emitting device), locators 820 may emit light in the visible band (e.g., about 500 nm to 750 nm), in the infrared band (e.g., about 750) nm to 1 mm), in the ultraviolet band (about 100 nm to 500 nm), some other portion of the electromagnetic spectrum, or some combination thereof.

In some embodiments, locators 820) are located beneath an outer surface of display device 805, which is transparent to the wavelengths of light emitted or reflected by locators 820 or is thin enough to not substantially attenuate the wavelengths of light emitted or reflected by locators 820. Additionally, in some embodiments, the outer surface or other portions of display device 805 are opaque in the visible band of wavelengths of light. Thus, locators 820 may emit light in the IR band under an outer surface that is transparent in the IR band but opaque in the visible band.

IMU 830 is an electronic device that generates calibration data based on measurement signals received from one or more position sensors 825. Position sensor 825 generates one or more measurement signals in response to motion of display device 805. Examples of position sensors 825 include: one or more accelerometers, one or more gyroscopes, one or more magnetometers, another suitable type of sensor that detects motion, a type of sensor used for error correction of IMU 830, or some combination thereof. Position sensors 825 may be located external to IMU 830, internal to IMU 830, or some combination thereof.

Based on the one or more measurement signals from one or more position sensors 825, IMU 830 generates first calibration data indicating an estimated position of display device 805 relative to an initial position of display device 805. For example, position sensors 825 include multiple accelerometers to measure translational motion (forward/back, up/down, left/right) and multiple gyroscopes to measure rotational motion (e.g., pitch, yaw, roll). In some embodiments, IMU 830 rapidly samples the measurement signals and calculates the estimated position of display device 805 from the sampled data. For example, IMU 830 integrates the measurement signals received from the accelerometers over time to estimate a velocity vector and integrates the velocity vector over time to determine an estimated position of a reference point on display device 805. Alternatively, IMU 830 provides the sampled measurement signals to console 810, which determines the first calibration data. The reference point is a point that may be used to describe the position of display device 805. While the reference point may generally be defined as a point in space: however, in practice the reference point is defined as a point within display device 805 (e.g., a center of IMU 830).

In some embodiments, IMU 830 receives one or more calibration parameters from console 810. As further discussed below, the one or more calibration parameters are used to maintain tracking of display device 805. Based on a received calibration parameter, IMU 830 may adjust one or more IMU parameters (e.g., sample rate). In some embodiments, certain calibration parameters cause IMU 830 to update an initial position of the reference point so it corresponds to a next calibrated position of the reference point. Updating the initial position of the reference point as the next calibrated position of the reference point helps reduce accumulated error associated with the determined estimated position. The accumulated error, also referred to as drift error, causes the estimated position of the reference point to “drift” away from the actual position of the reference point over time.

Imaging device 835 generates calibration data in accordance with calibration parameters received from console 810. Calibration data includes one or more images showing observed positions of locators 820 that are detectable by imaging device 835. In some embodiments, imaging device 835 includes one or more still cameras, one or more video cameras, any other device capable of capturing images including one or more locators 820, or some combination thereof. Additionally, imaging device 835 may include one or more filters (e.g., used to increase signal to noise ratio). Imaging device 835 is configured to optionally detect light emitted or reflected from locators 820 in a field of view of imaging device 835. In embodiments where locators 820 include passive elements (e.g., a retroreflector), imaging device 835 may include a light source that illuminates some or all of locators 820, which retro-reflect the light towards the light source in imaging device 835. Second calibration data is communicated from imaging device 835 to console 810, and imaging device 835 receives one or more calibration parameters from console 810 to adjust one or more imaging parameters (e.g., focal length, focus, frame rate, ISO, sensor temperature, shutter speed, aperture, etc.).

In some embodiments, display device 805 optionally includes one or more optical elements 860 (e.g., lenses, reflectors, gratings, etc.). In some embodiments, electronic display device 805 includes a single optical element 860 or multiple optical elements 860 (e.g., an optical element 860 for each eye of a user). In some embodiments, electronic display 815 projects computer-generated images on one or more optical elements 860, such as a reflective element, which, in turn, reflect the images toward an eye or eyes of a user. The computer-generated images include still images, animated images, and/or a combination thereof. The computer-generated images include objects that appear to be two-dimensional and/or three-dimensional objects. In some embodiments, one or more optical elements 860) are partially transparent (e.g., the one or more optical elements 860 have a transmittance of at least 15%, 20%, 25%, 30%, 35%, 50%, 55%, or 50%), which allows transmission of ambient light. In such embodiments, computer-generated images projected by electronic display 815 are superimposed with the transmitted ambient light (e.g., transmitted ambient image) to provide augmented reality images.

In some embodiments, one or more optical elements 860, or a subset there of, are positioned to modify light (e.g., ambient light) transmitted to electronic display 815. For example, the one or more optical elements 860 may include an optical dimmer to selectively reduce the intensity of light passing through the optical dimmer. In some embodiments, optical elements 860 include an optical device (e.g., 600, 710) described above with respect to FIGS. 6 and 7.

Input interface 840) is a device that allows a user to send action requests to console 810. An action request is a request to perform a particular action. For example, an action request may be to start or end an application or to perform a particular action within the application. Input interface 840 may include one or more input devices. Example input devices include: a keyboard, a mouse, a game controller, data from brain signals, data from other parts of the human body, or any other suitable device for receiving action requests and communicating the received action requests to console 810. An action request received by input interface 840 is communicated to console 810, which performs an action corresponding to the action request. In some embodiments, input interface 840 may provide haptic feedback to the user in accordance with instructions received from console 810. For example, haptic feedback is provided when an action request is received, or console 810 communicates instructions to input interface 840 causing input interface 840) to generate haptic feedback when console 810 performs an action.

Console 810 provides media to display device 805 for presentation to the user in accordance with information received from one or more of: imaging device 835, display device 805, and input interface 840. In the example shown in FIG. 8, console 810 includes application store 845, tracking module 850, and application engine 855. Some embodiments of console 810 have different modules than those described in conjunction with FIG. 8. Similarly, the functions further described herein may be distributed among components of console 810 in a different manner than is described here.

When application store 845 is included in console 810, application store 845 stores one or more applications for execution by console 810. An application is a group of instructions, that when executed by a processor, is used for generating content for presentation to the user. Content generated by the processor based on an application may be in response to inputs received from the user via movement of display device 805 or input interface 840. Examples of applications include: gaming applications, conferencing applications, video play back application, or other suitable applications.

When tracking module 850 is included in console 810, tracking module 850 calibrates system 800 using one or more calibration parameters and may adjust one or more calibration parameters to reduce error in determination of the position of display device 805. For example, tracking module 850 adjusts the focus of imaging device 835 to obtain a more accurate position for observed locators on display device 805. Moreover, calibration performed by tracking module 850 also accounts for information received from IMU 830. Additionally, if tracking of display device 805 is lost (e.g., imaging device 835 loses line of sight of at least a threshold number of locators 820), tracking module 850 re-calibrates some or all of system 800.

In some embodiments, tracking module 850 tracks movements of display device 805 using second calibration data from imaging device 835. For example, tracking module 850 determines positions of a reference point of display device 805 using observed locators from the second calibration data and a model of display device 805. In some embodiments, tracking module 850 also determines positions of a reference point of display device 805 using position information from the first calibration data. Additionally, in some embodiments, tracking module 850 may use portions of the first calibration data, the second calibration data, or some combination thereof, to predict a future location of display device 805. Tracking module 850 provides the estimated or predicted future position of display device 805 to application engine 855.

Application engine 855 executes applications within system 800 and receives position information, acceleration information, velocity information, predicted future positions, or some combination thereof of display device 805 from tracking module 850. Based on the received information, application engine 855 determines content to provide to display device 805 for presentation to the user. For example, if the received information indicates that the user has looked to the left, application engine 855 generates content for display device 805 that mirrors the user's movement in an augmented environment. Additionally, application engine 855 performs an action within an application executing on console 810 in response to an action request received from input interface 840 and provides feedback to the user that the action was performed. The provided feedback may be visual or audible feedback via display device 805 or haptic feedback via input interface 840.

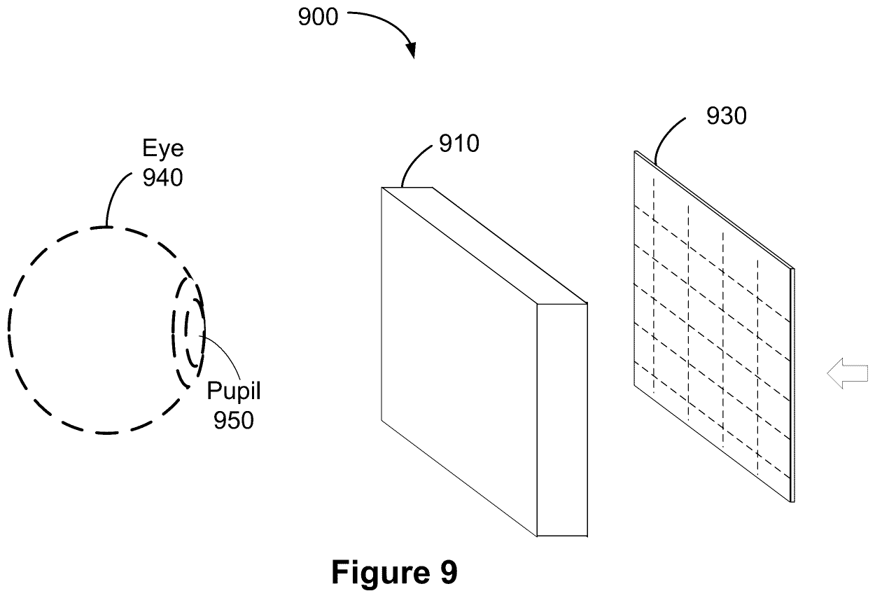

FIG. 9) is an isometric view of display device 900 in accordance with some embodiments. In some other embodiments, display device 900 is part of some other electronic display (e.g., a digital microscope, a head-mounted display device, etc.). In some embodiments, display device 900 includes an optical device (e.g., optical device 710), light emission device 910 (e.g., a light emission device array) and an optical assembly 930, which may include one or more lenses and/or other optical components. In some embodiments, display device 900 also includes an IR detector array.

Light emission device 910 emits image light and optional IR light toward the viewing user. Light emission device 910 includes one or more light emission components that emit light in the visible light (and optionally includes components that emit light in the IR). Light emission device 910 may include, e.g., an array of LEDs, an array of microLEDs, an array of organic LEDs (OLEDs), an array of superluminescent LEDs (sLEDS) or some combination thereof.

In some embodiments, light emission device 910 includes an emission intensity array (e.g., a spatial light modulator) configured to selectively attenuate light emitted from light emission device 910. In some embodiments, the emission intensity array is composed of a plurality of liquid crystal cells or pixels, groups of light emission devices, or some combination thereof. Each of the liquid crystal cells is, or in some embodiments. groups of liquid crystal cells are, addressable to have specific levels of attenuation. For example, at a given time, some of the liquid crystal cells may be set to no attenuation, while other liquid crystal cells may be set to maximum attenuation. In this manner, the emission intensity array is able to provide image light and/or control what portion of the image light is transmitted. In some embodiments, display device 900 uses the emission intensity array to facilitate providing image light to a location of pupil 950 of eye 940 of a user, and minimize the amount of image light provided to other areas in the eyebox. In some embodiments, display device 900 includes, or is optically coupled with, electro-optic devices operating as a display resolution enhancement component. In some embodiments, display device 900 is an augmented reality display device. In such embodiments, display device 900 includes, or is optically coupled with, electro-optic devices operating as a waveguide-based combiner or as a polarization selective reflector.

In some embodiments, the display device 900 includes one or more lenses. The one or more lenses receive modified image light (e.g., attenuated light) from light emission device 910, and direct the modified image light to a location of pupil 950. The optical assembly may include additional optical components, such as color filters, mirrors, etc.

In some embodiments, the optical assembly 930 includes an optical device (e.g., 710) described above with respect to FIGS. 7 and 8. The optical device 710 has a variable transmittance (e.g., has a first transmittance curve at a first time and a second transmittance curve distinct from the first transmittance curve at a second time mutually exclusive from the first time). The optical device 710 conditionally reduces intensity of light passing through the optical device 710. In some embodiments, the optical device 710 has only a single window that has a uniform transmittance across the window at each time (e.g., the optical device 710 operates as a single variable intensity filter). In some embodiments, the optical device 710 has a plurality of regions, as shown in FIG. 9, where each region may have a transmittance independent of transmittances of other regions.

An optional IR detector array detects IR light that has been retro-reflected from the retina of eye 940, a cornea of eye 940, a crystalline lens of eye 940, or some combination thereof. The IR detector array includes either a single IR sensor or a plurality of IR sensitive detectors (e.g., photodiodes). In some embodiments, the IR detector array is separate from light emission device 910. In some embodiments, the IR detector array is integrated into light emission device 910.

In some embodiments, light emission device 910 including an emission intensity array make up a display element. Alternatively, the display element includes light emission device 910 (e.g., when light emission device 910 includes individually adjustable pixels) without the emission intensity array. In some embodiments, the display element additionally includes the IR array. In some embodiments, in response to a determined location of pupil 950, the display element adjusts the emitted image light such that the light output by the display element is refracted by one or more lenses toward the determined location of pupil 950, and not toward other locations in the eyebox.

In some embodiments, display device 900 includes one or more broadband sources (e.g., one or more white LEDs) coupled with a plurality of color filters, in addition to. or instead of, light emission device 910.

In light of these principles, we now turn to certain embodiments.

In accordance with some embodiments, a stack of optical layers (e.g., the portion of the optical device 600 of FIG. 6) includes a first transparent oxide layer (e.g., glass substrate 120 of FIG. 1A, first layer 610 of FIG. 6) having a first surface and a first set of surface coatings (e.g., 630, 640, . . . ) disposed thereon. Each surface coating in the first set of surface coatings is bonded to another surface coating in the first set of surface coatings. A first surface coating in the first set of surface coatings is bonded to the first surface (e.g., first coating 630 is bonded to a first surface of first layer 610 as illustrated in FIG. 6), thereby attaching the first set of surface coatings to the first transparent oxide layer. At least one surface coating in the first set of coatings is a partial reflective coating. In some embodiments, all of the surface coatings in the first set of coating is partially reflective. The optical device includes a second transparent oxide layer (e.g., glass substrate 220 of FIG. 2A, second layer 620 of FIG. 6) having a second surface and an opposing third surface, with a second set of surface coatings (e.g., third coating 650 of FIG. 6) disposed thereon. Each surface coating in the second set of surface coatings is bonded to another surface coating in the second set of coatings, and a first surface coating in the second set of surface coatings is bonded to the third surface. At least one surface coating in the second set of surface coatings is a partial reflective coating. In some embodiments each surface coating in the second set of surface coatings is a partial reflective coating. An outer surface coating (e.g., silicon dioxide coating. second coating 640 in FIG. 6) in the first set of surface coatings is covalently bonded to the second surface of the second transparent oxide layer through a plurality of covalent interactions of the form X—O—Y (670 in FIG. 6), thereby attaching the first transparent oxide layer and the second transparent oxide layer to each other. Each X is an atom of the outer surface coating of the first set of surface coatings (e.g., second coating 640) in FIG. 6), O is an oxygen atom (e.g., represented by element 670 in FIG. 6), and each Y is an atom of the second transparent oxide layer (e.g., layer 620 of FIG. 6). For example, referring to FIG. 3D, dashed circle 303 illustrates this arrangement, where the lower silicon atom is the X in the formula X—O—Y, the central oxygen atom in dashed circle 303 is the O in the formula X—O—Y, and the upper silicon atom is the Y in the formula X—O—Y. The first and second transparent oxide layers are thus attached to each other (through the intervening bonded coatings, as illustrated in FIG. 6). In some embodiments the optical device 600 (e.g., first and second transparent oxide layers together with the coatings) collectively have a bow of less than 200 micrometers, less than 150 micrometer, less than 100 micrometers or less than 50 micrometers across a first planar dimension (e.g., a length or width of the layers as opposed to its thickness). In some embodiments the optical device 600 (e.g., first and second transparent oxide layers together with the coatings) have a total thickness variation (TTV) of less than 5 microns. While some attention has been drawn to an optical device having two substrates (e.g., in FIG. 6 the two substrates are first layer 610 and second layer 620), as illustrated in FIG. 1, there can be more than two substrates, each having an associated set of coatings in the same manner that has been described for the first two substrates. Thus, with reference to FIG. 1, in some embodiment the “n” illustrated in FIG. 1 is a positive integer of 2, 3, 4, 5, 6, 7, 8, 9, 10, or greater than 10.

In some embodiments, with reference to the X—O—Y, formula, the second transparent oxide layer is composed of silicon dioxide and each Y is a silicon (Si) atom. In some embodiments, each X and each Y is a Si atom. In some embodiments, the second transparent oxide layer is composed of zirconium oxide and each Y is a Zr atom. In some embodiments, the second transparent oxide layer is composed of titanium dioxide and each Y is a Ti atom. In some embodiments, the second transparent oxide layer is composed of aluminum oxide and each Y is an Al atom. In some embodiments, the second transparent oxide layer is composed of indium tin oxide and each Y is an In or Sn atom. In some embodiments, the second transparent oxide layer is composed of bismuth oxide and each Y is a Bi atom. In some embodiments, the second transparent oxide layer is composed of lanthanum oxide and each Y is a La atom. In some embodiments, the second transparent oxide layer is composed of yttrium oxide and each Y is an atom of yttrium. In some embodiments, each X and each Y is independently a Si, Zr, Ti, Al, In, Sn, Bi, La, or yttrium atom.

In some embodiments, a coating in the first set of coatings is an index-matching coating, a dielectric multilayer coating, a partially transmissive coating, or a graded index coating.

In some embodiments, a coating in the second set of coatings is an index-matching coating, a dielectric multilayer coating, a partially transmissive coating, or a graded index coating.

In some embodiments, the optical device is an augmented reality device.

In some embodiments, the outer surface coating in the first set of surface coatings is deposited on the first surface coating in the first set of surface coatings.

In some embodiments, the first surface coating has a microroughness of less than 2 nm.

In some embodiments, the first surface coating has a microroughness of less than 0.5 nm.

In some embodiments, a second surface coating in the first set of surface coatings is deposited on the first surface coating, and the outer surface coating in the first set of surface coatings is deposited on the second surface coating in the first set of surface coatings.

In some embodiments, the second surface coating has a microroughness of less than 2 nm.

In some embodiments, the second surface coating has a microroughness of less than 0.5 nm.

In some embodiments, the second surface of the second transparent oxide layer has a microroughness of less than 2 nm.

In some embodiments, the second surface of the second transparent oxide layer has a microroughness of less than 0.5 nm.

In some embodiments, the first transparent oxide layer is a portion of a wafer that is 100 mm, 150 mm, 200 mm, or 300 mm in diameter.

In some embodiments, the first transparent oxide layer has surface area that is between 3 mm and 50 mm in a first dimension and between 3 mm and 50 mm in a second dimension orthogonal to the first dimension.

In some embodiments, a thickness of the first transparent oxide layer varies between 50 microns and 1 mm.

In some embodiments, a thickness of the second transparent oxide layer varies between 100 nm and 900 nm.

In some embodiments, the first transparent oxide layer is a core layer of a waveguide.

In some embodiments, the at least one surface coating in the first set of surface coatings is a cladding layer of the waveguide.

In some embodiments, the at least one surface coating in the first set of surface coatings is a metal oxide coating or a dielectric coating.

In some embodiments, the at least one surface coating in the first set of surface coatings is partially transmissive to visible light.

In accordance with some embodiments, a head-mounted display device (e.g., 600) includes a display and an optical device (e.g., 610) that includes: a first transparent oxide layer having a first surface and a first set of surface coatings, wherein each surface coating in the first set of surface coatings is bonded to another surface coating in the first set of surface coatings, and a first surface coating in the first set of surface coatings is bonded to the first surface, thereby attaching the first set of surface coatings to the first transparent oxide layer, at least one surface coating in the first set of coatings is a partial reflective coating. The optical device includes a second transparent oxide layer having a second surface and an opposing third surface, and a second set of surface coatings, wherein each surface coating in the second set of surface coatings is bonded to another surface coating in the second set of coatings, and a first surface coating in the second set of surface coatings is bonded to the third surface, at least one surface coating in the second set of surface coatings is a partial reflective coating. An outer surface coating in the first set of surface coatings is covalently bonded to the second surface of the second transparent oxide layer through a plurality of covalent interactions of the form X—O—Y, thereby attaching the first transparent oxide layer and the second transparent oxide layer to each other. Each X is an atom of the outer surface coating of the first set of surface coatings, O is an oxygen atom, each Y is an atom of the second transparent oxide layer, and wherein the first and second transparent oxide layers attached to each other collectively have a bow of less than 100 micrometers or have a total thickness variation (TTV) of less than 5 microns.

Although head-mounted displays are illustrated as apparatus that include the described optical devices, such optical devices may be used in other systems, devices, and apparatus. For example, the optical devices described herein may be used as smart windows (for buildings or vehicles) or switchable shutters.

Terms, “and” and “or” as used herein, may include a variety of meanings that are also expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features. structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AC, BC, AA, ABC, AAB, AABBCCC, etc.

The methods, systems, and devices discussed above are examples. Various embodiments may omit, substitute, or add various procedures or components as appropriate. For instance, in alternative configurations, the methods described may be performed in an order different from that described, and/or various stages may be added, omitted, and/or combined. Also, features described with respect to certain embodiments may be combined in various other embodiments. Different aspects and elements of the embodiments may be combined in a similar manner. Also, technology evolves and, thus, many of the elements are examples that do not limit the scope of the disclosure to those specific examples.

Specific details are given in the description to provide a thorough understanding of the embodiments. However, embodiments may be practiced without these specific details. For example, well-known circuits, processes, systems, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing various embodiments. Various changes may be made in the function and arrangement of elements without departing from the spirit and scope of the present disclosure.

Although various drawings illustrate operations of particular components or particular groups of components with respect to one eye, a person having ordinary skill in the art would understand that analogous operations can be performed with respect to the other eye or both eyes. For brevity, such details are not repeated herein.

Although some of various drawings illustrate a number of logical stages in a particular order, stages which are not order dependent may be reordered and other stages may be combined or broken out. While some reordering or other groupings are specifically mentioned, others will be apparent to those of ordinary skill in the art, so the ordering and groupings presented herein are not an exhaustive list of alternatives. Moreover, it should be recognized that the stages could be implemented in hardware, firmware, software or any combination thereof.

The foregoing description, for purpose of explanation, has been described with reference to specific embodiments. However, the illustrative discussions above are not intended to be exhaustive or to limit the scope of the claims to the precise forms disclosed. Many modifications and variations are possible in view of the above teachings. The embodiments were chosen in order to best explain the principles underlying the claims and their practical applications, to thereby enable others skilled in the art to best use the embodiments with various modifications as are suited to the particular uses contemplated.

What is claimed is:

1. An optical device comprising:
a first transparent oxide layer having a first surface:
a first set of surface coatings, wherein
each surface coating in the first set of surface coatings is bonded to another surface coating in the first set of surface coatings, and
a first surface coating in the first set of surface coatings is bonded to the first surface, thereby attaching the first set of surface coatings to the first transparent oxide layer,
at least one surface coating in the first set of coatings is a partial reflective coating:
a second transparent oxide layer having a second surface and an opposing third surface:
a second set of surface coatings, wherein
each surface coating in the second set of surface coatings is bonded to another surface coating in the second set of coatings, and
a first surface coating in the second set of surface coatings is bonded to the third surface,
at least one surface coating in the second set of surface coatings is a partial reflective coating: wherein
an outer surface coating in the first set of surface coatings is covalently bonded to the second surface of the second transparent oxide layer through a plurality of covalent interactions of the form X—O—Y, thereby attaching the first transparent oxide layer and the second transparent oxide layer to each other,
each X is an atom of the outer surface coating of the first set of surface coatings,
O is an oxygen atom,
each Y is an atom of the second transparent oxide layer: and wherein
the first and second transparent oxide layers attached to each other collectively have a bow of less than 100 micrometers or have a total thickness variation (TTV) of less than 5 microns.

2. The optical device of claim 1, wherein second transparent oxide layer is composed of silicon dioxide and each Y is a Si atom.

3. The optical device of claim 1, wherein each X and each Y is a Si atom.

4. The optical device of claim 1, wherein the second transparent oxide layer is composed of zirconium oxide and each Y is a Zr atom.

5. The optical device of claim 1, wherein the second transparent oxide layer is composed of titanium dioxide and each Y is a Ti atom.

6. The optical device of claim 1, wherein the second transparent oxide layer is composed of aluminum oxide and each Y is an Al atom.

7. The optical device of claim 1, wherein the second transparent oxide layer is composed of indium tin oxide and each Y is an In or Sn atom.

8. The optical device of claim 1, wherein the second transparent oxide layer is composed of bismuth oxide and each Y is a Bi atom.

9. The optical device of claim 1, wherein the second transparent oxide layer is composed of lanthanum oxide and each Y is a La atom.

10. The optical device of claim 1, wherein the second transparent oxide layer is composed of yttrium oxide and each Y is an atom of yttrium.

11. The optical device of claim 1, wherein each X and each Y is independently a Si, Zr, Ti, Al, In, Sn, Bi, La, or yttrium atom.

12. The optical device of claim 1, wherein a coating in the first set of coatings is an index-matching coating, a dielectric multilayer coating, a partially transmissive coating, or a graded index coating.

13. The optical device of claim 1, wherein a coating in the second set of coatings is an index-matching coating, a dielectric multilayer coating, a partially transmissive coating, or a graded index coating.

14. The optical device of claim 1, wherein the optical device is an augmented reality device.

15. The optical device of claim 1, wherein the outer surface coating in the first set of surface coatings is deposited on the first surface coating in the first set of surface coatings.

16. The optical device of claim 1, wherein the first surface coating has a microroughness of less than 2 nm.

17. The optical device of claim 1, wherein the first surface coating has a microroughness of less than 0.5 nm.

18. The optical device of claim 1, wherein a second surface coating in the first set of surface coatings is deposited on the first surface coating, and the outer surface coating in the first set of surface coatings is deposited on the second surface coating in the first set of surface coatings.

19. The optical device of claim 18, wherein the second surface coating has a microroughness of less than 2 nm.

20. The optical device of claim 18, wherein the second surface coating has a microroughness of less than 0.5 nm.

21. The optical device of claim 1, wherein the second surface of the second transparent oxide layer has a microroughness of less than 2 nm.

22. The optical device of claim 1, wherein the second surface of the second transparent oxide layer has a microroughness of less than 0.5 nm.

23. The optical device of claim 1, wherein the first transparent oxide layer is a portion of a wafer that is 100 mm, 150 mm, 200 mm, or 300 mm in diameter.

24. The optical device of claim 1, wherein the first transparent oxide layer has surface area that is between 3 mm and 50 mm in a first dimension and between 3 mm and 50 mm in a second dimension orthogonal to the first dimension.

25. The optical device of claim 1, wherein a thickness of the first transparent oxide layer varies between 50 microns and 1 mm.

26. The optical device of claim 1, wherein a thickness of the second transparent oxide layer varies between 100 nm and 900 nm.

27. The optical device of claim 1, wherein the first transparent oxide layer is a core layer of a waveguide.

28. The optical device of claim 27, wherein the at least one surface coating in the first set of surface coatings is a cladding layer of the waveguide.

29. The optical device of claim 27, wherein the at least one surface coating in the first set of surface coatings is a metal oxide coating or a dielectric coating.

30. The optical device of claim 27, wherein the at least one surface coating in the first set of surface coatings is partially transmissive to visible light.
